(19) United States
(12) Patent Application Publication
(10) Pub. No.: US 2014/0278935 A1
(43) Pub. Date: Sep. 18, 2014

(54) SYSTEM AND METHOD OF PROVIDING ONLINE OFFERS THROUGH SOCIAL MEDIA PLATFORMS

(71) Applicant: VIONIC, INC., San Diego, CA (US)

(72) Inventor: Kosta K. Gara, Coronado, CA (US)

(73) Assignee: Vionic, Inc., San Diego, CA (US)

(21) Appl. No.: 13/867,981

(22) Filed: Apr. 22, 2013

Related U.S. Application Data
(63) Continuation of application No. 13/830,568, filed on Mar. 14, 2013, now abandoned.

(51) Int. Cl. G06Q 30/02; G06Q 50/00

(52) U.S. Cl. CPC G06Q 30/0251; G06Q 50/01
USPC 705/14.45

(57) ABSTRACT

Systems and methods for providing online offers integrated with social network-based platforms are disclosed. Offer details are provided to a server, and the server is configured to generate a customer offer application and/or widget which is integrated with the social networking page of the business creating the offer. Viral marketing features are provided which allow the online offer to reach wider audiences at a minimal cost to the business making the online offer.

### CROSS-REFERENCE TO RELATED APPLICATIONS

This application is a continuation of and claims a priority benefit to U.S. patent application Ser. No. 13/830,568, entitled “System and Method of Providing Online Offers Through Social Media Platforms,” filed Mar. 14, 2013. Any and all priority claims identified in the Application Data Sheet, or any correction thereto, are hereby incorporated by reference under 37 C.F.R. §1.57.

### BACKGROUND OF THE INVENTION

1. Field of the Invention

This application relates to online offers. In particular, this application relates to systems and methods which enable businesses to create, design, publish, and collect payment for sales offers provided through multiple platforms including social networks.

2. Description of the Related Art

Because traditional advertising via television and radio media are relatively expensive, small and medium-sized businesses (“SMB's”) have turned to the Internet as a resource for advertising their goods and services to the general public. Initially, these efforts centered on the placement of advertisements within websites and also within search engine results. In recent years, online advertising has moved beyond simple electronic media advertisement placement and into other more interactive forms of advertising. These newer forms of online advertising have included the use of online contests and daily deal web sites.

Systems offered by contest creators have been typically designed to drive traffic to social media pages by enticing users with contests, giveaways, and promotions. These systems have typically focused on attracting web traffic, gathering information about their users, such as demographic information for example, and converting those users into “fans,” “followers” or some other type of increased level of engagement. By converting those users, the contest creators increase social engagement with their users. These contest creators often offer their services to those businesses who seek increased engagement with their customers. In most cases, contest creators do not directly monetize, create transactions, or engage in e-commerce activity.

Daily deal sites are typically designed to curate coupons and connect consumers to SMB's. These sites typically offer coupons or other discounts which may be redeemed at SMB's for a short period of time, such as 24 hours, for example. The coupons may be accessed via a website, or alternatively may be sent to consumers via e-mail or some other indication channel. Consumers are invited to purchase those coupons through the daily deal site and redeem those coupons at the SMB associated with the component. Daily deal sites are typically not automated, and instead are labor-intensive as employees of the daily deal sites typically work directly with the SMB's to develop the deals which will be presented through the site. The process of creating is often prolonged due to the extensive interaction between the SMB in the daily deal site which must take place before the deal runs on the site. Daily deal sites also lack flexibility in the types of deals that SMB's may create. In most cases, SMB's are not given the ability to control discount percentage, duration, start time, and payment collection. Rather, since the daily deal site sells the discount directly to the consumer, it first collects payment. Only later, typically 6 to 8 weeks after the deal ends, does the SMB receive payment for the coupon sold on the site. Because the deal coupons can be redeemed immediately upon purchase by the consumer, the SMB is often providing goods and services for which it will receive payment only several weeks later. This type of protocol can create severe cash-flow problems for a small business. In short, none of the existing approaches for marketing SMB's effectively allows them to find new and loyal customers in a manner that involves reduced risk and a reasonable cost.

### SUMMARY

In one embodiment, a system for providing online offers for sale of goods or services from a business to a consumer is provided. The system may include data storage configured to store offer details. The system may further include a server comprising at least one processor configured to generate a custom offer for goods or services offered by the business. The custom offer may be based on the stored offer details and is integrated into a social network platform and displayed on a social network web page. The process may be further configured to receive data indicative of a consumer choice to purchase the customer offer. The processor may then process the received data so as to receive payment for the purchased offer, wherein the receipt of payment comprises depositing a portion of the received payment into a payment account associated with the business. The processor may further be configured to generate voucher indicative of the purchased good or service and then transmit data indicative of the voucher to the consumer.

In another embodiment, a method of providing online offers for sale of goods or services from a business to a consumer is provided. The method includes storing offer details in a database and generating a custom offer for goods or services offered by the business, based on the stored offer details. The custom offer is integrated into a social network platform and displayed on a social network web page. The method further includes receiving data indicative of a consumer choice to purchase the customer offer and processing the received data so as to receive payment for the purchased offer. The receipt of payment may include depositing a portion of the received payment into a payment account associated with the business. A voucher indicative of the purchased good or service is generated, and data indicative of the voucher is transmitted to the consumer.

### BRIEF DESCRIPTION OF THE DRAWINGS

FIG. 1 is a high level system diagram of a network environment suitable for implementing a system for generating online offers in accordance with one or more embodiments of the invention.

FIG. 2 is a more detailed view of the online offer system shown in FIG. 1.

FIG. 3 is a flow diagram showing an example of one process by which an online offer may be created by an SMB according to one or more embodiments.

FIG. 4 is a flow diagram of one example process for defining an online offer campaign using a simple and intuitive process according to one or more embodiments of the invention.

FIG. 5 is an example of a process by which the consumer may purchase an online offer from an SMB utilizing the online offer system shown in FIG. 1.

FIGS. 6A through 6G are examples of user interfaces which may be used by SMB's to manage and edit their online offers according to one or more embodiments.

FIGS. 7A and 7B are examples of online offers which have been published into a social media environment in accordance with one or more embodiments disclosed herein.

### DETAILED DESCRIPTION OF CERTAIN INVENTIVE EMBODIMENTS

Embodiments of the inventions disclosed herein provide a software platform which enables SMB's to create, design, publish, and collect discounted offers on multiple platforms without the need for involving intermediary parties whose interests lie primarily promoting their own businesses, and not the business of the SMB. Embodiments disclosed herein further provide SMB's with full and complete control over the details of their sales offers, including the timing, discounting, and payment terms for these offers; they no longer need satisfy requirements imposed upon them by daily deal site. Still further, using the systems and methods described herein, SMB's are able to communicate directly with their customers, thereby enabling them to foster the development of those relationships.

FIG. 1 is a high level view of a networking environment 100 suitable for implementing systems and methods described herein. The networking environment 100 includes a network 102. The network 102 may take various forms. It may be a wide area network (WAN) such as, for example, the Internet. It may also include one or more local area networks (LANs) which are connected to the WAN. Still further, the network 102 may include various dedicated network connections, such as virtual private networks, leased lines, and the like. The network may provide wired and/or wireless connections, so some other types of connectivity as is known it the art. In general, the network 102 may be collection of computers which transmit and/or communicate information to each other either directly, or via one or more intermediate networking devices.

The networking environment 100 also includes an online offer system 104. The online offer system 104, which is discussed in detail below, generally provides for the ability of SMB's to create online offers for distribution via the network 102. The networking environment 100 and also include consumer client devices 106. The consumer client devices 106 generally take the form of computers owned, used, and/or controlled by the general public, which may be used to access other computers via the network 102. The consumer client devices 106 may be traditional personal computers, hand-held computers, smart phones, cellular telephones, laptop computers, tablet computers, or any other type of computing device used by a consumer to access computer networks. The networking environment 100 may also include one or more social networks 108. The social networks 108, as is well known in the art, may be online services, websites, or other online platforms which facilitate communication between users having common friends, interests, and/or backgrounds. Well-known examples of social networks include Facebook, Google+, MySpace, and Twitter. These social media platforms generally provide the ability for users to create accounts, and user's accounts to connect to other users, and share information about themselves and/or their interests via the social network.

The networking environment 100 may also include SMB client devices 110. The SMB client devices 110, like consumer client devices, they generally be any one of various types of different computing devices. The SMB client devices 110 are computers owned, used, and/or controlled by small and medium-sized businesses and/or their respective employees for the purpose of facilitating their business endeavors. The SMB client devices 110 may be used by the SMB's in connection with various aspects of their business related to online services. For example, the SMB client devices 110 may be used to create, manage, or otherwise use a SMB website 112. SMB devices 110 may also be used to connect to the online offer system 104 to create and distribute online offers as will be discussed in detail below. The SMB client devices 110 may further be used to manage accounts on one or more of the social networks 108. These accounts may be associated with the SMB's, and may provide to them with a presence within the social network from which they may access and communicate with customers and potential customers alike. Although a specific example of a network environment 100 is shown in FIG. 1, a skilled artisan will readily appreciate that this is merely one example of a networking environment suitable for implementing the systems and methods described herein, and that a networking environment may include additional entities, parties, components, and devices not shown in FIG. 1.

FIG. 2 is a more detailed view of the online offer system 104 shown in FIG. 1. The online offer system 104 includes various components and modules which allow SMB's to create and manage their online offers. The online offer system 104 includes a campaign creation module 202. The campaign creation module, which will be discussed in additional detail below, typically take the form of a software application which can be accessed from SMB client devices 110, and used to create a campaign of online offers directed to potential customers and customers of the SMB. The online offer system 104 may also include a social network integration module 204. The social network integration module 204 is a software module which connects to various social networks via application programming interfaces (API's) or through some other connection protocol. The social network integration module 204 allows for campaigns created by the campaign creation module 202 to be placed easily within social media pages associated with the SMB.

The online offer system 104 may further include a widget generator 206. The widget generator 206 is a software module configured to access information regarding campaigns created using the campaign creation module 202, and use that information to generate custom widgets which allow consumers to accept the online offers using their consumer client computer devices 106 of the network 102. Examples of these generated custom widgets will be provided in further discussion below. The online offer system 104 may further include a social network crawler 208. The social network crawler 208 may take the form of a set of custom applications designed to access social networks. The social network crawler may be configured to retrieve public information from one or more social networks, based on different criteria, so SMB's can use this feature to address specific needs. These needs may include searching for keywords and/or gathering information relevant to their current or next campaign.

The online offer system 104 may also include a payment processor 210. The payment processor 210 is a software module configured to receive payment information from external users, and process that payment information to effectuate payment for goods and services. The payment processor 210 may be integrated into the online offer system 104, or alternatively, it may be provided by a third-party service such as, PayPal, for example.

The online offer system 104 may further include a coupon generation module 212. The coupon generation module 212 is generally configured to, upon receipt of payment from a consumer for an online offer, generate an electronic coupon which may be downloaded by the consumer so that it can be presented for redemption to the SMB associated with the coupon. The electronic coupons may take various forms. In some embodiments electronic coupons may be PDF files which can be downloaded and printed by the consumer and presented to the SMB at the time of purchase. In some embodiments, coupons may be e-mailed to the consumer. In other embodiments, the electronic coupons may be documents that include QR codes or some other scannable imprint, which can be scanned on the premises of the SMB in order to effectuate redemption. In still other embodiments, the electronic coupons may be stored electronically in a coupon database associated with the consumer. These electronic coupons may have codes which may be used to redeem the online offer in the context of a purchase made via the network 102.

The online offer system 104 may further include a reporting module 214. The reporting module is typically configured to allow an SMB to obtain an overview of its campaigns—including both expired and current campaigns. Additionally, the reporting module 214 may be further configured to provide reports regarding sales associated with each of the specific campaigns. The online offer system 104 may also include one or more APIs 216 which are used to integrate the online offer system with systems associated with third parties. These APIs 216 may be used to share data with third-party systems, and alleviate the need for users such as SMB's and/or consumers to provide data to the system that can be obtained through other third-party systems. By way of example, an API 216 may be provided to integrate a pre-existing payment account on behalf of an SMB with the online offer system. However it is to be appreciated, that other types of API integration may be provided in order to ease the burden on the user of entering and sharing data. For example, API's may be used to integrated with data providers such as Yelp for map information and business information. Other API's may be used to integrated to leverage other services such as analytics, sharing and publication, e-mail services, and the like.

As discussed previously, embodiments of the invention allow for SMB's to generate online offers which may be distributed via social networking platforms, web platforms, and mobile platforms. FIG. 3 is a data flow diagram which provides one example of how an online offer system 104 may be used by an SMB to generate and publish online offers in accordance with one or more embodiments. The process begins at block 302, where the SMB accesses the online offer system 104. Typically, the SMB will be asked to log into the system either with a new account or an existing account. Once the SMB has logged in, the process moves to decision block 304, where the system determines whether the SMB is an existing user or not. If the SMB is not an existing user, the process moves to block 306 where a new user is created in the process continues. Once the new user has been created, the information associated with that user may be stored in a user information database such as database 308. If at decision block 304, the SMB user is an existing user, the process moves immediately to block 310 where the campaign creation process is initiated. Typically, this process is performed by the campaign creation module 202. As part of initiating the campaign creation process, the system 104 next determines whether the user has published an online offers campaign previously at decision block 312. If it is not the first time that the user has published an online campaign using the campaign creation module 202, at block 312, the process moves immediately to block 318 so the user can publish their online offer campaign.

If the system 104 determines that the logged in user is publishing a campaign for the first time, the process moves to decision block 314 to determine whether the user has credit within the system. In this particular embodiment the need to check whether the user has credit arises from the fact that the SMB may be required to pay a service fee in order to create an online offer campaign. However, it should be appreciated that in some embodiments, a service fee need not be charged. If at decision block 314 is determined that the user has no credit, the process moves to block 316, where the SMB is connected to the payment processing module 212 so that the SMB may pay the service fee associated with publishing the campaign using the system 104. Once the user has provided payment via the payment processor 210, the process moves to block 318 where the SMB defines the online offer campaign, which may be stored in the campaigns database 320 and associated with the specific SMB for later retrieval from the database. Returning to decision block 314, if the user has credit, the system need not require payment to allow the user to define and publish their online offer campaign, and the process moves from decision block 314 to block 318 as described above.

Once the SMB has inputted all of the necessary information for creating the campaign at block 318, the campaign creation module 202 may then generate a campaign widget at block 322 using the widget generation module 206 (examples of the generated campaign widget will be discussed in additional detail below). Having generated an online campaign widget, the process next moves to blocks 324, 326, and 328, where the campaign widget is posted to various platforms where it can be viewed by consumers for potential purchase of goods and services. In particular, at block 324, the widget is posted to social networking platforms, such as social networks 108 shown above in FIG. 1. The process of posting the generated widget to social networks 108 may be performed by the social network integration module 204. Alternatively, a more generic API such as third-party APIs 216 may be used.

The generated campaign widget may also be posted to web-based platforms as shown in block 326. A web-based platform may be the website of the SMB, or some other web-based platforms such as an advertising platform or possibly a website associated with the online offer system 104. For example, the campaign widget may be posted on a webpage of the SMB so that customers visiting its website can take advantage of the online offer by using the widget to purchase discounted goods or services. The generated campaign widget may also be posted with a search engine such as Google or Bing, where it can be presented within the search results presented in connection with certain relevant keywords. The campaign widget may also be posted to mobile-based platforms as shown in block 328. For example, the campaign widget may be posted to a twitter account associated with the SMB, or with some other entity, such as a person associated with the SMB. Thus, when an SMB publishes a campaign, they have broad capabilities for posting a link to that campaign or “widget”. In addition, the SMB is also able to suggest or request that coupon buyers share a link to the widget in various social networks.

Turning now to FIG. 4, a more detailed flow diagram of the process described in connection with block 318 from FIG. 3 is provided. In particular, in certain embodiments, a SMB may employ a six step process to create an online offer campaign. This six step process begins at block 402, where the SMB begins the initial setup process. Typically, the initial setup process involves selecting a locality in which the online offer will be displayed to consumers. For example, the initial setup process may involve receiving a selection of a country in which the online offer campaign will run. Next, the process moves to block 404, where the SMB selects or provides images to be used in assembling the campaign widget which will present the online offer. In some embodiments, the images may be selected from a database of images provided by the system 104. Alternatively, the user may be asked to provide its own image for use in the promotion. When the user is asked to provide its own image for use in the promotion, the system 104 may specify that the image fall within certain parameters. For example, the user may be required to provide an image that is a specified number of pixels tall and a specified number of pixels wide.

Once the user has selected the image the process then moves to block 406. There, the user inputs a headline and/or title for the online offer that is being created. The headline and/or title is typically descriptive in nature, and may be used to entice consumers to consider purchasing the good or services advertised in the online offer. Next, the process moves to block 408, where the SMB inputs the deal information. The deal information typically consists of information which indicates to the consumer that the SMB is offering advantageous pricing for the advertised good or service. For example, the deal information may include an identification of the item or service, the original price and a discounted price. Additionally, the deal information may specify the number of offers available for purchase. By providing a limited number of offers to be made available, the SMB is provided control over the volume of heavily discounted business that is provided to the general public. In addition, specifying a limited number of available coupons may serve as a call to action for consumers considering whether to make a purchase. The deal information may further include a termination date for the deal. Providing a termination date of the deal may also create a sense of emergency on the part of the consumer. Finally, the deal information may include payment details. In particular, the payment details they provide information regarding where fees collected from the online offer should be deposited. Typically, this information will include account information related to the SMB creating the online offer. For example, the payment details may include information about a PayPal account. Alternatively, other types of payment details may be provided such as bank account information, merchant account information, or some other type of account information which allows for collected funds to be delivered to the SMB.

Once the deal information has been provided, the process moves to block 410. There, additional details about the deal are collected. These details may include the “fine print” about the online offer. This “fine print” may include limitations on the deal such as limiting it to first-time customers only, expiration dates for redemption of any coupon, and limits as to the number of deals that may be purchased by any single person. In addition, the location of the SMB associated with the online offer may also be provided. This location may be used to provide location-based placement of the advertisement within webpages, search results, mobile platforms, and social networks.

Once the deal details have been provided, the process moves to block 412. There, the SMB gives final details regarding the online offer, and submits it for publishing by the system 104. In some embodiments, the user may select specific websites, mobile platforms, social media account pages to which the offer will be published. Certain embodiments, the SMB may select its own Facebook page as the target for publication. Upon receiving the publication details, the widget generator 206 of the system 104 may generate a widget and distribute it to the selected targets.

Once the widget has been published, it is then available to consumers via the websites, social networks, and mobile platforms selected by the SMB. The consumer, using a consumer client device 110, may access the published widget and purchase the online offer from the SMB. FIG. 5 is a flow diagram providing an example of the coupon buying experience that may be undertaken by a consumer in accordance with one or more embodiments. The process begins at block 502, where the consumer accesses a webpage with the generated widget included therein. The consumer may access this page using various types of client devices, including a personal computer, a tablet, a mobile phone, and the like. Moreover, the consumer may access the widget via one or more of a social media platform, a web platform, and a mobile platform.

When the consumer makes a decision to purchase an online offer from the SMB, the process moves to block 504 where the consumer provides payment via a payment processing module, such as payment processing module 210 described in connection with FIG. 2. The processing of the payment moves to block 506, where the transaction fee is collected, and then divided between the provider of the online offer system 104 (shown as item 508 in the diagram) and the SMB (shown as item 510). Thus, the SMB receives immediate payment for the online offer, and is not required to wait for several weeks as is typical in the daily deal sites previously known in the art.

Once payment has been received and processed, the process moves to block 512. There, an electronic coupon is generated which can be later redeemed with the SMB by the consumer who has made the purchase. In some embodiments, the coupon may be generated by a dedicated software modules such as the coupon generation module 212 described above in connection with FIG. 2. Once the electronic coupon has been generated, it may be delivered to the consumer in various ways. For example, the coupon may be sent to the consumer as a PDF printable attachment sent in an e-mail to an address provided by the consumer and shown in block 514. Similarly, the coupon may be transmitted to the consumer as a downloadable and printable file as shown in block 516. Finally, the system 104 may provide the consumer with online repository in which the consumer may store his or her purchased coupons in a database as shown in block 518. Irrespective of the method of delivery, the SMB benefits by receiving immediate payment for the purchased online offer, while sharing only a small transaction fee with the online offer service provider.

FIGS. 6A-6J provide examples of a user interface which may be used by SMB's to create, manage, and distribute their online offers using systems such as those described above in connection with FIGS. 1-5 above. FIG. 6A is an example of a user interface which may be presented to and SMB to complete the six step process of creating an online offer according to embodiments disclosed herein. As shown, the user interface includes a control menu 1000 the control menu 1000 includes various buttons which may be used by the SMB to initiate the process of building an online offer campaign. The user interface also includes a navigation menu 1002 which may be used to guide the SMB through the process, such as the process described above in connection with FIG. 4. Finally, the user interface of FIG. 6A also may include a video element. In the example shown, an online video 1004 is displayed to the user, and may be used to provide the user with instructions on how to implement the process for creating and publishing the online offer campaign.

Turning now to FIG. 6B, an example interface is shown which may be used by SMB to manage multiple campaigns associated with their account on the system 104. As shown, the control menu includes additional buttons 1010 associated with the pre-existing saved and/or published campaigns. The SMB user may these additional buttons to obtain additional information about sales generated by these deals. The interface may also include user interface elements 1012 and 1014 for navigation amount accounts with many different campaigns. The example interface may also include image elements 1016 which provide thumbnail images and links to additional details about of the various campaigns stored in the campaign database.

Turning now to FIG. 6C, an example interface is provided that shows sales information associated with the various campaigns shown in FIG. 6B above. Here, the user has selected the appropriate button 1020 in the interface, which results in a sales chart 1024 being displayed to the user and showing up-to-date sales information regarding each of the campaigns. In addition, a search box 1024 may be provided to assist the SMB in locating desired information.

FIG. 6D is an example of a user interface that may be used to track redemptions of the online offers purchased by consumers. As shown, the user interface includes a control 1030. As shown, the SMB user is given the opportunity to enter a code from the coupon voucher into a text field 1032. The SMB user may submit this code by clicking on the redeem button, which will store this information in the database and update the sales information accordingly.

FIGS. 6E through 6G provide examples of how and SMB user may effectively distribute an online campaign via various types of platforms and social media. FIG. 6E is example of a user interface which allows and SMB user to search for and connect with potential customers using a microblogging service such as Twitter, for example. In this particular example, the SMB is able to conduct a time and location relevant, customer search for people interested in the product being sold by the SMB. For example, the SMB may enter a keyword in the search field 1042, which in turn will search for potential customers and return a list of those customers 1044.

Turning now to FIG. 6F, an example of a user interface suitable for distributing the online offer via a mobile communication platform is provided. The interface 1050 includes a menu 1052 which displays a mobile friendly URL. The SMB user may use this mobile friendly URL to send to mobile devices using text messaging services, for example. The interface 1060 may further include an interface 1054 to provide an SMS-based campaign. FIG. 6G provides yet another mechanism for distributing the online offer to a wider audience. Here, a mailing interface 1060 may include a mailing list menu 1062 shown in FIG. 6G. The mailing list menu 1062 may provide detailed instructions which allow the SMB user to send the offer via e-mail using various e-mail clients. Alternatively, the SMB user may also be able to send e-mail using an API to an e-mail distribution list via a third-party provider 1064.

Turning now to FIG. 7A, an example of a user interface 2000 and showing an online offer which has been distributed by the widget generator to a social network platform. In this example, the social network platform is the well-known social networking application Facebook. The user interface 2000 shows a “fan” page for a SMB 2002, in this case “Fred's Bar.” The system 104 has placed an entry point 2006 to the widget created by the campaign within the list of applications 2004 associated with the fan page.

FIG. 7B provides an example of a user interface 2010 in which the online offer 2012 is displayed to a consumer via the social networking platform which has received the online offer from the widget generator. As shown, the offer includes an image 2013 that was selected by the SMB as part of the six step offer definition process described above. The offer 2012 also includes a title, as was entered by the SMB user during the creation process as well. Various other elements including a map 2014 showing the location of the SMB, offer details 2016 providing detailed information that was entered by the SMB as well as various additional deal information is provided. This deal information may include the amount of time left to purchase the deal (which is defined by the date of expiration provided by the SMB). The deal may also include the price 2020, a purchase but in 2019, as well as additional information about the value of the deal 2018. In addition, the display deal may include a link 2015 to other online offers generated by the online offer system 104. Providing this link allows for cross marketing and benefits both the online offer provider and the various SMB's utilizing the system.

Those of skill will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks modules, circuits, and steps have been described above generally in terms of their functionality. Whether such functionality is implemented as hardware or software depends upon the particular application and design constraints imposed on the overall system.

Skilled artisans may implement the described functionality in varying ways for each particular application, but such implementation decisions should not be interpreted as causing a departure from the scope of the present invention. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CDROM, or any other form of storage medium known in the art. An exemplary storage medium is coupled to the processor such the processor can read information from and write information to, the storage medium. In the alternative, the storage medium may be integral to the processor.

The processor and the storage medium may reside in an ASIC. The ASIC may reside in a user terminal or some other type of device. In the alternative the processor and the storage medium may reside as discrete components in a user terminal.

1. A system for providing online offers for sale of goods or services from a business to a consumer, comprising:
data storage configured to store offer details, the offer details including a discounted price;
a server comprising at least one processor configured to:
generate a custom offer for goods or services offered by the business, the custom offer based on the stored offer details and including the discounted price, wherein the custom offer is integrated into a social network platform and displayed on a social network web page;
receive data indicative of a consumer choice to purchase the goods or services at the discounted price, the data indicative of a consumer choice to purchase the goods or services generated in response to consumer interaction with the custom offer;
process the received data so as to receive payment for the goods or services;
deposit a portion of the received payment into a payment account associated with the business;
generate a voucher indicative of the purchased goods or service; and
transmit data indicative of the voucher to the consumer.

2. The system of claim 1, wherein the processor is further configured to integrate the custom offer into a microblogging service.

3. The system of claim 1, wherein the processor is further configured to publish the custom offer to a mobile platform.

4. The system of claim 1, wherein the data indicative of the voucher transmitted to the consumer includes a printable coupon sent via e-mail to the consumer.

5. The system of claim 1, wherein the data indicative of the voucher transmitted to the consumer includes a printable coupon transmitted as a downloadable document to the consumer.

6. The system of claim 1, wherein the processor is further configured to, prior to generating the custom offer for goods or services offered by the business, receive information from the business indicative of an account associated with the business for receiving payment from consumers.

7. The system of claim 6, wherein the processor is further configured to automatically deliver at least a portion of payment received from the consumer to the account associated with the business.

8. The system of claim 7, wherein a portion of the payment received is also delivered to an account associated with a provider of the system for providing online offers.

9. A method of providing online offers for sale of goods or services from a business to a consumer, the method comprising
storing, by a processor, offer details in a database, the offer details including a discounted price;
generating, by the processor, a custom offer for goods or services offered by the business, the customer offer based on the stored offer details and including the discounted price, wherein the custom offer is integrated into a social network platform and displayed on a social network web page;
receiving, by the processor, data indicative of a consumer choice to purchase the goods or services at the discounted price, the data indicative of a consumer choice to purchase the goods or services generated in response to consumer interaction with the custom offer;
processing, by the processor, the received data so as to receive payment for the goods or services;
depositing, by the processor, a portion of the received payment into a payment account associated with the business;
generating, by the processor, a voucher indicative of the purchased goods or service; and
transmitting, by the processor, data indicative of the voucher to the consumer.

10. The method of claim 9, further comprising integrating the custom offer into a microblogging service.

11. The method of claim 9, further comprising publishing the custom offer to a mobile platform.

12. The method of claim 9, wherein transmitting data indicative of the voucher to the consumer comprises transmitting a printable coupon sent via e-mail to the consumer.

13. The method of claim 9, wherein transmitting data indicative of the voucher to the consumer comprises transmitting a printable coupon transmitted as a downloadable document to the consumer.

14. The method of claim 9, further comprising, prior to generating the custom offer for goods or services offered by the business, receiving information from the business indicative of an account associated with the business for receiving payment from consumers.

15. The method of claim 14, further comprising delivering at least a portion of payment received from the consumer to the account associated with the business.

16. The method of claim 15, wherein a portion of the payment received is also delivered to an account associated with a provider of the system for providing online offers.

17. The system of claim 1, wherein the custom offer for goods or services comprises a countdown of the amount of time left to purchase or a termination date for the offer.

18. The system of claim 1, wherein the custom offer for goods or services comprises an indicator of the number of available vouchers.

19. The system of claim 1, wherein the custom offer for goods or services requires the consumer to share the custom offer within the social network in order to purchase the goods or services.

20. The system of claim 1, wherein the server comprising at least one processor is further configured to present an interface for generation and publication of custom offer campaigns, the interface adapted for a user associated with the business, the interface comprising features allowing the user to configure one or more custom offers associated with a campaign.
